(19) United States
(12) Patent Application Publication
(10) Pub. No.: US 2013/0033876 A1
(43) Pub. Date: Feb. 7, 2013

(54) LENS FOR LED

(71) Applicant: Franco Venturini, Buccinasco (MI) (IT)

(72) Inventor: Franco Venturini, Buccinasco (MI) (IT)

(21) Appl. No.: 13/641,625

(22) PCT Filed: Apr. 13, 2011
(86) PCT No.: PCT/IT11/00112

§ 371 Date: Oct. 16, 2012

(30) Foreign Application Priority Data
Apr. 16, 2010 (IT) CR2010A000012

(51) Int. Cl. F21V 5/04

(52) U.S. Cl. 362/311.02

(57) ABSTRACT

An improved lens (1) for LED (L), includes: an optical body (2) with a substantially truncated-cone or circular paraboloid shape, with a larger base (3) facing outwards and a smaller base (4) arranged for receiving, in a special recess (5), a LED (L) associated to an electronic board (6) coupled to a support base (11); a top closing wall (13) associated to the larger base (3); side walls (7), integral with the optical body and the top closing wall, arranged for delimiting a space volume (V) included between the side surface (2′) of the optical body, the inside surface (7′) of the walls (7), the top closing wall and the face of the electronic board (6) associated to the support base, wherein the lens includes a solid shaped block (8), arranged for filling the space volume (V) and for coupling with the side walls, cooperating therewith by interference.

The invention relates to the lighting field: in particular, the invention concerns an improved lens for LED, usable in lighting systems in association with lighting devices and bodies of various types.

Lenses for LEDs are known from the Italian patent application no. CR2009A000023 by the same applicant, which are made of a plastic material, for example methacrylate, arranged for being associated to single LEDs for creating particular optical and lighting effects. Said lenses essentially comprise an inside optical body, side walls and a top closing wall.

Said optical body has a substantially truncated-cone or paraboloid shape and is provided with a larger base associated to said top closing wall and a smaller base provided with a special recess wherein a LED may be inserted.

Said LED, along with other LEDs, is associated to an electronic board coupled to a support base.

Said top closing wall may has a surface that is smooth or suitably processed with regular geometrical relief patterns, for directing the light emitted by the LED in various manners.

Said side walls are arranged for surrounding said optical body for preventing dusts, vapors and gases from soiling the same body and reducing the efficiency of the lens, delimiting a well-defined space volume within the same lens.

In particular, when the lens is in position, said space volume is comprised between said top closing wall, the side surface of said optical body, the inside surface of said side walls, and the face of said electronic board coupled to said support base.

Said side walls are integral with said optical body and said top closing wall, for forming a single block element, and they comprise a plurality of support feet arranged for being inserted into corresponding holes provided on said support base,

These lenses for LEDs have some limits and drawbacks.

When mounted on a LED, each lens encloses a space volume filled with air that, when the LED contained therein is turned on or off, or during sudden changes in temperature in the surrounding environment, may expand or compress due to the difference in temperature. The consequent pressures or vacuums that generate within the lens may cause the inlet of air, gas, vapors and dust and may affect the operation of the LED it is associated to, In extreme cases, they may also lead to the breakage of the side walls of the lens, made of thin methacrylate surfaces.

This type of lens, therefore, does not allow a perfect insulation to gases, dusts or liquids of the LED therein, and does not allow keeping the air volume incorporated underneath the lens during the assembly unchanged.

During the assembly of the lens onto the LED it is possible to interpose sealing material between the bottom edges of said walls and the face of said electronic board associated to the support base: disadvantageously, however, the fixing surface is extremely reduced, as it is represented by the thickness of the side walls, and the seal is not ensured.

In short, therefore, the use of these lenses on lighting fixtures affects the use thereof in environments with a risk of explosion, but with the use of sealed enclosures that are expensive and affect the lighting efficiency, and therefore it greatly limits the application thereof, for example in the industrial field.

Aim of the invention is to eliminate such drawbacks improving the functional performance compared to a traditional lens.

In particular, the invention aims at:
minimizing the air volume contained in the lens for preventing excessive positive and/or negative pressure variations;
making the lens perfectly sealed to gases, dusts and liquids, providing a wider sealing surface;
stiffening the connecting walls increasing the mechanical resistance thereof.

Such aims are achieved by an improved lens for LED, comprising:
an optical body with a substantially truncated-cone or circular paraboloid shape, with a larger base facing outwards and a smaller base arranged for receiving, in a special recess, a LED associated to an electronic board coupled to a support base;
a top closing wall associated to said larger base of said optical body;
side walls, integral with said optical body and said top closing wall, arranged for delimiting a space volume, where said space volume is comprised between the side surface of said optical body, the inside surface of said walls, the top closing wall and the face of said electronic board associated to said support base,

characterized in that it comprises a solid shaped block, arranged for filling said space volume and for coupling with said side walls, cooperating therewith by interference.

According to a preferred aspect of the invention, the face of said block facing said electronic board is arranged at the same height as the bottom edges of said side walls.

According to a further preferred aspect of the invention, said block comprises a plurality of support feet arranged for inserting into corresponding holes provided on said electronic board and/or on said support base.

Advantageously, said block is made of a high resistance material, preferably polymeric, and even more preferably polycarbonate.

The advantages resulting from the construction aspects mentioned above consist in obtaining better functional performance of the lens.

In particular, the presence of the polycarbonate block:
substantially reduces the air volume enclosed by the lens to zero and prevents the onset of dangerous sudden pressure variations due to the expansion and contraction of said air volume;
provides a larger fixing surface whereon sealing materials can be applied for creating a perfect insulation of the LED and making the lens sealed to gases, dusts and liquids;
stiffens the side walls, imparting greater mechanical resistance to the entire lens,

Moreover, the presence of the support feet located directly onto said block, rather than on the side walls, allows an easier positioning of the lens onto the LED, divided into two steps: a first step of application and sealing of the block onto the LED, a second step of coupling by interference onto the block of the single block lens element, consisting of the optical body, the side walls and the top closing wall.

If sealing materials are used for insulating the LED, the direct application thereof onto the block is easier, the dose is more controlled and since the single block element is only positioned at a later time, it is protected from becoming soiled due to possible leaks of said materials in excess.

These and further advantages of the invention shall appear more clearly from the following description of a preferred embodiment, made by way of an indicative and non-limiting example with reference to the figures, wherein:

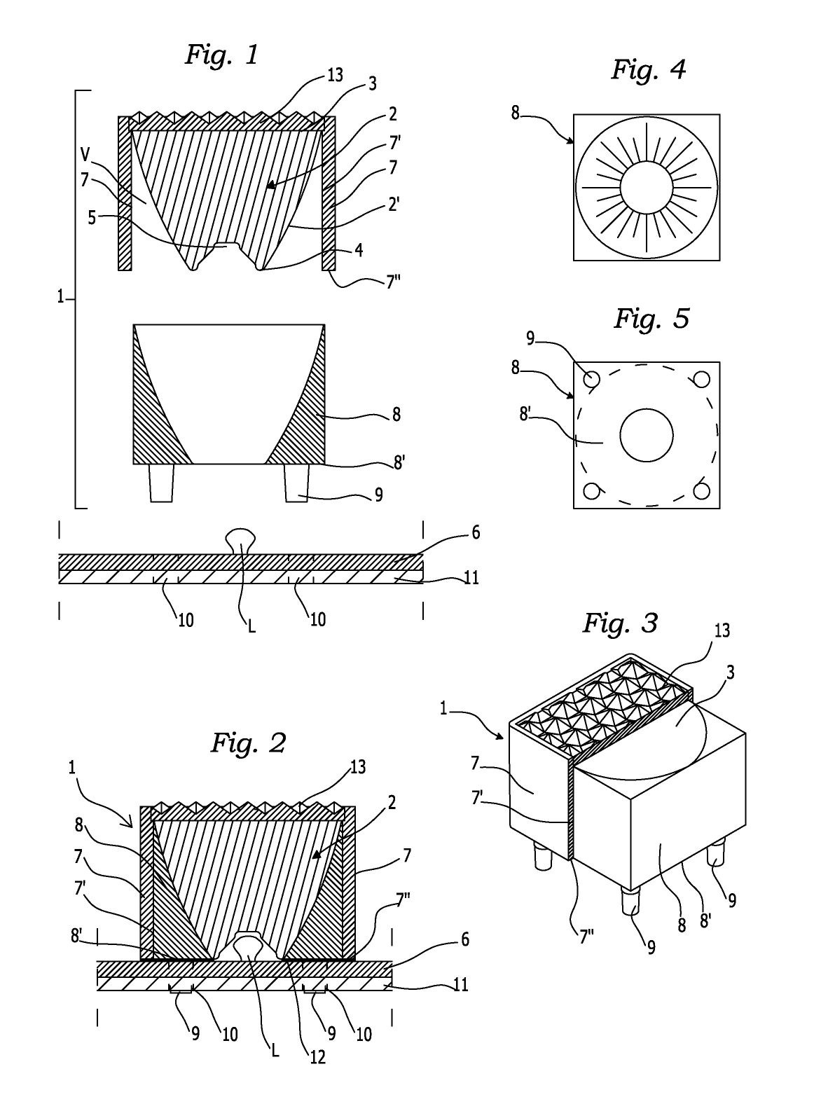

FIG. 1 shows a partly exploded cutaway view of an improved lens for LED according to a vertical plane, made according to the invention;

FIG. 2 shows a cutaway view of an improved lens for LED according to a vertical plane, assembled in use;

FIG. 3 shows a partly cutaway axonometric view of the lens FIG. 1;

FIGS. 4 and 5 respectively show a top and bottom view of a component of said improved lens for LED according to the invention.

With reference to FIGS. 1-3, the improved lens 1 for LED L essentially comprises an optical body 2, side walls 7 and a top closing wall 13, integrated with one another so as to form a single block element.

Said optical body 2 has a substantially truncated-cone or circular paraboloid shape and it has a larger base 3 facing outwards and a smaller base 4 arranged for receiving, in a special recess 5, a LED L during use.

Said LED L is associated to an electronic board 6 coupled to a suitable support base 11.

Also said top closing wall 13, associated to said larger base 3, has an optical function and is smooth or suitably processed with regular geometrical relief bumps for suitably directing the light emitted by the LED.

Said side walls 7 are arranged for separating the optical body 2 from the outer environment, delimiting a space volume V comprised between said top closing wall 13, the side surface 2′ of said optical body 2, the inside surface T of said side walls 7 and the face of said electronic board 6 LED L is associated to.

Said lens 1 further comprises a solid shaped block 8, arranged for filling said space volume V of the single block element consisting of said optical body 2, said connecting walls 7 and said top closing wall 13, and for coupling by interference with said walls 7.

In particular, face 8 of said block 8 facing said electronic board 6 is arranged at the same height as the bottom edges 7″ of said side walls 7, and has a considerably larger surface compared to the surface of said edges 7″, so as to provide a considerably large support area onto board 6 or onto the support base 11.

Such face 8′ therefore allows associating block 8 to board 6 or to base 11 in a gas, vapor and dust sealed manner, thanks to the interposition of a layer of elastic sealing material 12, such as for example acetic acid based silicone.

Said block 8 further comprises a plurality of support feet 9 arranged for being inserted into corresponding holes 10 provided on said support base 11 and optionally on said electronic board 6.

With particular reference to FIGS. 4 and 5, said block 8, made of a particularly resistant plastic polymer, for example polycarbonate, has the main face 8′, that is the one suitable for facing said electronic board 6, with a substantially square shape with a central hole suitable for receiving the smaller base 4 of said optical body 2, and said support feet 9 are arranged at the four corners of said face.

The improved lens 1 for LED L generally has a polygon shape with four sides, but it can easily take a hexagon, octagon or circle shaped base in relation to construction requirements or to the different possible applications for different light effects.

As a consequence, the face of said block facing said electronic board can take different polygonal shapes according to the general shape of the lens for LED said block is associated to.

The surface of the top closing wall 13 may be smooth or processed without distinction and of course, the invention may be embodied in several shapes, dimensions and processing versions, adjusting to the insertion into various LED lighting devices.

A method of using the invention is as follows.

A first step provides for coupling the electronic board 6, whereon LED L is connected, to a support base 11, with the particular care of mating holes 10 provided on both components.

Subsequently, said block 8 is associated to electronic board 6 in correspondance to LED L, inserting the support feet 9 into said holes 10.

In order to ensure perfect insulation of LED L with the surrounding environment, while the main face 8′ of said block 8 is placed onto the outer face of the electronic board 6, it is necessary to interpose a layer of sealing material 12.

Said sealing material advantageously is of the elastic type for compensating and absorbing the thermal expansions of the support base and of the electronic board, and preventing the detachment of the lens or the forming of micro-cracks. Preferably, said elastic sealing material is acetic acid based silicone

Subsequently, the single block element of lens 1, consisting of the optical body 2, of the side walls 7 and of the top closing wall 13, is inserted by interference on said shaped block 8, resting the bottom edges 7″ of walls 7 of lens 1 on the outer face of the electronic board 6 or onto that of the support base 11.

Block 8 entirely occupies the space volume V comprised between the side walls, the top closing wall, the optical body and the electronic board, and the presence of air within the lens is prevented but for a poor and unimportant amount.

The contact and sealing surface between said lens and said electronic board whereon the LED is mounted is wide and ensures good air and mechanical seal.

The single LED is perfectly insulated from the surrounding environment, with the guarantee, for the entire lens, of maximum sealing to gases, dusts and liquids, and of a good lighting efficiency over time without the risk of breakage or explosions, also in the case of short circuits or failures of the LED.

As is clear to the man skilled in the art, besides with a single light diffusing element, the invention may also be used in association with a plurality of LEDs for making ceiling lamps, lamps and actual lighting bodies, in the most varied shapes and dimensions, always achieving the advantages described above.

1. Improved lens (1) for LED (L), comprising:
an optical body (2) with a substantially truncated-cone or circular paraboloid shape, with a larger base (3) facing outwards and a smaller base (4) arranged for receiving, in a special recess (5), a LED (L) associated to an electronic board (6) coupled to a support base (11);
a top closing wall (13) associated to said larger base (3) of said optical body (2);
side walls (7), integral with said optical body (2) and said top closing wall (13), arranged for delimiting a space volume (V), where said space volume (V) is comprised between the side surface (2′) of said optical body (2), the inside surface (7′) of said walls (7), the top closing wall (13) and the face of said electronic board (6) associated to said support base (11),
characterized in that it comprises a solid shaped block (8), arranged for filling said space volume (V) and for coupling with said side walls (7), cooperating therewith by interference.

2. Improved lens (L) for LED (1) according to claim 1, characterized in that the face (8′) of said block (8) facing said electronic board (6) is arranged at the same height as the bottom edges (7′) of said side walls (7).

3. Improved lens (1) for LED (L) according to claim 1, characterized in that said block (8) comprises a plurality of support feet (9) arranged for inserting into corresponding holes (10) provided on said electronic board (6) and/or on said support base (11).

4. Improved lens (1) for LED (L) according to claim 1, characterized in that said block (8) is made of a high-resistance material.

5. Improved lens (1) for LED (L) according to claim 4, characterized in that said block (8) is made of a polymeric material.

6. Improved lens (1) for LED (L) according to claim 5, characterized in that said polymeric material is polycarbonate.

7. LED lighting appliance characterized in that it comprises an improved lens (1) for LED (L) according to claim 1.
